(19) United States
(12) Patent Application Publication
(10) Pub. No.: US 2009/0320601 A1
(43) Pub. Date: Dec. 31, 2009

(54) Ultrasound Test Device with Array Test Probes

(76) Inventor: Wolf-Dietrich Kleinert, Bonn (DE)

Correspondence Address: MCCARTER & ENGLISH, LLP HARTFORD;CITYPLACE I, 185 ASYLUM STREET, HARTFORD, CT, 06103, US

(21) Appl. No.: 12/304,767

(22) PCT Filed: May 31, 2007
(86) PCT No.: PCT/EP2007/055298

§ 371 Date: Dec. 14, 2008

(30) Foreign Application Priority Data
Jun. 14, 2006 (DE) 102006027956.5

(51) Int. Cl. G01N 29/04

(52) U.S. Cl. 73/628

(57) ABSTRACT

The invention relates to a method for representing ultrasound signals which are obtained with the aid of an ultrasound test device for the non-destructive testing of a test body. The ultrasound test device has at least two array test heads, each having a plurality of individual transmitters and a plurality of receivers, and a monitor having a display. The method has the following method steps: the array test heads are placed onto a coupling face of the test body, ultrasound pulses are acoustically radiated into the test body at particular angles using the first array test head, ultrasound signals are received with the aid of the first array test head, an error is found and cultivated from a first acoustic irradiation direction, further acoustic irradiation positions and directions of the two array test heads are calculated on the basis of a known wall thickness of the test body and a known angle of the first direction, the extent of the error is determined on the basis of propagation times and amplitudes of the acoustic irradiation directions.

### CROSS-REFERENCE TO RELATED APPLICATIONS

This application is the U.S. National Stage of International Application No. PCT/EP2007/055298, filed May 31, 2007, which claims priority to German Application No. DE 10 2006 027 956.5, filed Jun. 14, 2006, both of which are hereby incorporated by reference as part of the present disclosure.

### BACKGROUND OF THE INVENTION

The invention relates to an ultrasonic test apparatus for non-destructive testing of a test body and to a method for imaging ultrasonic signals obtained with the help of an ultrasonic test apparatus.

For non-destructive testing of a workpiece by means of ultrasounds, suited test apparatus are known. Very generally, the reader is referred to the DE book of J. and H. Krautkrämer, Werkstoffprüfung mit Ultraschall, (Material Test by Means of Ultrasounds), sixth edition.

Angle-beam probes are more specifically known, which deliver sound pulses at high frequencies (about 1-10 MHz), said pulses being insonified into the workpiece under test and being then reflected from the coupling surface and returning to the angle-beam probe on the one side and penetrating into the workpiece where they are at least once reflected from a back wall of the workpiece on the other side. Sound reflections occur from inner inhomogeneities such as material flaws, said reflections being received from the angle-beam probe and processed in the ultrasonic apparatus.

Usually, one works with the pulse echo method. Preferably, the angle-beam probe, or a pulser, delivers periodically ultrasonic pulses and a receiver then receives echo signals of these delivered ultrasonic pulses. The other echo signals originate from the workpiece and in particular from the back wall of the workpiece. Insofar, the test method is suited for workpieces the coupling surface of which extends substantially parallel to the back wall so that the ultrasonic pulse reciprocates several times in the workpiece.

An angle-beam probe operates via a base made of lead material using oblique insonification. The ultrasonic wave enters into the material until partial or total reflection occurs at a boundary surface. If the reflecting surface is perpendicular to the direction of propagation, the sound wave is reflected in its original direction and, after a certain propagation time, reaches a piezoelectric oscillator disposed in the angle-beam probe, said oscillator converting it back into an electric pulse.

The angle-beam probe is disposed next to the region under test and the sound signal is insonified so to say laterally into the region of concern. This is for example the case in ultrasonic weld seam inspection.

On an intact body under test, the sound is reflected between a respective coupling surface and the back wall of the test body and propagates ever further into the body under test, at a certain angle in the direction leading away from the angle-beam probe.

When testing weld seams, the angle-beam probe is moved along the weld seam until a maximum flaw echo occurs. The received echo signals are displayed immediately on the monitor. The imaging occurs generally as what is referred to as an A scan, in which the voltage values of the echo signals received are plotted against the time axis. When the pulses move several times back and forth between the coupling surface and the back wall, one obtains a sequence of evenly spaced-apart echo signals the amplitude of which generally decreases as time increases. The discrete reciprocations, meaning the distance the sound travels from the coupling surface to the back wall and back, are respectively referred to as a leg. Starting from the angle-beam probe, a first leg is first generated, which extends at an incline from the coupling surface to the back wall. There, the sound is reflected and a second leg forms, which extends from the back wall to the coupling surface, and so on.

The location of the position of a reflector (flaw) in the body under test is calculated on the basis of the known and measured data. The echo amplitude is used for estimating the size of the flaw. This however is not reliably possible since the echo amplitude is subjected to many more influences than the sound propagation time.

Methods are known, which allow for estimating the size of the flaw or of the discontinuity. In these methods, the size (diameter) of a model reflector (circular disc, cylindrical reflector) is estimated. The thus obtained size is not identical with the actual size of the flaw and is therefore referred to as the equivalent diameter of the circular disc or of the transverse bore. If circular disc reflectors are being used, the shorter designation of substitute reflector size has become generally accepted. That the actual flaw size does not coincide with the substitute reflector size is due to the fact that the sound portions reflected by a natural flaw are additionally influenced by the shape, orientation and surface feature of the flaw. Since further inspection thereof is difficult and not very practicable in manual ultrasonic testing, the criteria for registering flaws are associated with a certain substitute reflector size in most specifications and guidelines. This means: the operator checks whether a flaw that has been found is equal to or greater than the substitute reflector size which was indicated as the limit value (registration limit) in the body of rules and regulations. He must further carry out further investigations such as with respect to the length of registration, the echo dynamics, and so on, which however will not be discussed further herein.

In particular when testing occurs with an angle-beam probe, the problem is that, if the flaw, for example a crack, is oriented parallel to the sound path in the extreme case, it is very probable that the sound will miss the flaw. If the sound, by contrast, hits the flaw, it is reflected and the signal is registered. On the basis of the substitute reflector size, a flaw is obtained, which appears to be very small on the monitor. It does not appear clearly that the flaw extends to a considerably larger extent in the direction of the sound path.

The geometry of the body under test becomes particularly clear if the body under test is also shown in cross section. This is possible if the wall thickness of the body under test is known. Since the insonification angle at which the sound is insonified into the body under test, starting from the angle-beam probe, is known, it is also possible to image the trajectory of the sound through the body under test.

The document DE 102 59 658 describes a method by means of which the imaging of a flaw detected by means of an angle-beam probe on a display is improved. The measurement result is not or not only imaged as a so-called A-scan; instead, the geometry of the body under test is shown on the display. This imaging is possible because insonification into the body under test occurs in two method steps from two directions. With the help of the reference standard method a detected flaw is directly imaged true to scale in cross sectional images which are optically superimposed so to say. The disadvantage of this method is that the result must at first be stored after a first test. Then, another test is performed from another direction and the results are then joined together. Although this method indeed leads to an improved imaging on the display, it involves much expense in terms of time and work. Additionally, what is referred to as the growing of the flaw occurs separately from two directions, which also takes time and does not always lead to the best result.

This is where the present invention comes in. It is its object to improve evaluation of ultrasonic signals that are obtained with the help of an ultrasonic test apparatus for non-destructive testing of a body. The statements with regard to the orientation of the flaw and to the kind of flaw, for example whether the flaw is planar or voluminous, should be as accurate as possible. The test operation should be faster and easier than with known test methods. Moreover, a suited ultrasonic test apparatus and a method for testing a body are proposed.

### SUMMARY OF THE INVENTION

In accordance with the invention, the object is achieved by a method having the features of claim 1 and by an ultrasonic test apparatus having the features of claim 10.

In the sense of the present invention, the term of flaw is not only to be understood literally, meaning not only in the sense of discontinuity, but should also be understood in the sense of a significant signal. Accordingly, the invention includes finding any relevant places in a body under test.

The invention uses two array probes. In principle, an array is a single oscillator that is divided into many individual elements. Typical element widths range from 0.5 mm to about 2.5 mm, other dimensions being of course possible. The term of array also includes what are referred to as annular antenna arrays, meaning round oscillators or elements that are divided into concentrically shaped individual elements.

The use of several small oscillators makes it possible to obtain dynamic focusing and pivotal movement of the sound bundle. Moreover, sound transmission is particularly effective since smaller elements need less excitation energy. As receivers, they already respond very efficiently because of the small mass to be excited. A large oscillator delivers a large planar scan but, since it is fanned out to a quite small extent (small divergence), the finding of flaws is limited. Small oscillators, by contrast, have a much larger angle of divergence.

Further, the capability of generating a dynamically variable ultrasound bundle and of thus having available a “virtual probe” speaks in favor of the use of an array probe. Thus, any insonification angle can be adjusted within the sound bundle characteristic of the individual oscillator.

So-called phased array probes excite the discrete elements at different points in time, a wavefront being generated as a result thereof, which is characterized by sound lobes irradiating with a delay with respect to each other. This wavefront resembles the sound field of a conventional angle-beam probe. Through variations in the delay times, different sound fields can be generated.

In accordance with the invention, the pivotal movement of the sound bundle is also utilized within the frame of a test to dynamically focus a sound beam. This is achieved by an electronic unit that makes it possible to correspondingly choose the actuation of the individual elements and can at the same time delay the pulses. In principle, a focal point is moved through the body under test. The combination of dynamic focusing and of pivotal movement of the sound bundle results in a sound bundle that is focused and impinges at an angle at the same time.

In accordance with the invention, what is referred to as a linear scanning can be utilized in which regrouped oscillator groups are actuated one after the other. A scanning effect is thus generated. The width of the sound lobe migrating through the body under test and the sampling rate can be fixed by the number of the simultaneously actuated individual elements and by the offset from one pulse to the other.

Advantageously, the material test occurs using the pulse-echo technique, two array probes being utilized which can be insonified from two directions into the region under test. An array probe can for example be disposed on one side of a weld seam and the other array probe on the opposite side of the weld seam on a coupling surface of a body under test. The two array probes are both insonified (not concurrently) into the weld seam. Both array probes or their pulsers and receivers can send and receive ultrasonic signals. What matters thereby is that the two array probes are calibrated with respect to each other, i.e., the distance between the two array probes or between the discrete oscillator elements within the array probes is known. If this distance, the gain of the body under test and the insonification angle are known, the distance between the array probes can be controlled during testing. This can for example be calculated through the duration of the sound from one array probe to the other (sound transmission in V-shape configuration).

The virtual probe is displaced electronically for example from the left to the right within the array probe so that the sound bundle largely covers the whole volume of the weld seam. At first, insonification occurs with only one array probe. If a flaw or a discontinuity is found, the echo display is grown or maximized through electronic displacement of the virtual probe. The flaw can thereby be hit directly or indirectly, meaning after reflection from the back wall. After optimization of the flaw signal, at least three further insonification positions can be computed when the wall thickness and the insonification angle are known and the virtual probes can be actuated accordingly, one after the other. Three further insonification positions are e.g., obtained if the two array probes insonify. Two direct sound paths and two indirect sound paths, meaning sound paths which are reflected from the back wall, to the flaw are obtained. Eight measurement values, namely four travel time values and four amplitude values, can be derived or obtained for the four insonification values. In accordance with the invention, it is in principle also possible to generate and to calculate further travel time values and amplitude values by varying the insonification angles.

Substitute reflector sizes can be determined from the amplitude values either according to the reference standard method or according to what is called the DGS-method (distance, gain, size).

A major advantage of the invention is that it can be told whether the flaw is voluminous or planar. If it is for example a voluminous flaw, all the four echo displays will have an approximately comparable amplitude. In case of a planar flaw, by contrast, two amplitudes will have much higher values than the two other amplitudes.

In addition to the amplitude evaluation, the evaluation of the travel time values can be used to obtain the size by comparing the sum of the travel times belonging to through transmission in V-shape to the overall travel time for undisturbed through transmission in V-shape configuration. The difference between these two values yields the extension of the reflector in the corresponding insonification direction. Accordingly, the extension results from the difference between the travel time for a complete through transmission in V-shape and the sum of the travel times. In accordance with the invention, the method described is repeated for all the flaws and discontinuities in the cross section under test. According to need, testing can be repeated accordingly with other insonification angles in order to even further improve detection of the actual flaw size. In order to ensure perfect measurement, through transmission in V-shape should be performed at time intervals between the two array probes for controlling coupling. The method described can be repeated with corresponding frequency in a next dimension, meaning for example along the course of a weld seam, in order to be capable of testing a weld seam or also one single flaw along its entire length. In accordance with the invention, it is also possible to move the array probes so to say virtually alongside the weld seam or the flaw. The insonification point can be displaced both across the weld seam and alongside the weld seam. If the array probes have the corresponding size, very large surfaces or lengths can be tested without mechanically displacing the array probes. In accordance with the invention, the two array probes are mechanically joined together. It has been found particularly advantageous if the distance between them can be changed or if the mechanical connection can be adjusted in length. The mechanical connection can comprise a scale from which the distance between the two array probes can be read. Advantageously, the mechanical connection consists of a kind of frame that comprises two reception regions for a respective array probe. These two reception regions are joined together through a mechanical connection and can be moved toward each other or away from each other. In a particularly advantageous implementation variant, the distance between the two reception regions is constantly calculated electronically and is transmitted to the electronic unit for further processing and computing. Thus, a double control is obtained, namely through the sound duration from one array probe to the other and through the electronic distance control. The sound path is referred to as the V-path. In accordance with the invention, the frame-like mechanical connection is configured to be flexible so that light irregularities on the coupling surface of the probe can be leveled out.

Insonification from two directions also effects that a flaw which lies at an incline can be determined quickly in two directions with respect to its propagation. The data of the two array probes are received by an electronic unit and are immediately processed. Thus, two images of the flaw are generated at the same time and are immediately placed one above the other and can be grown directly by the operator. Accordingly, the method of the invention is very effective and fast.

The measurement result is thereby not imaged or not only imaged as what is referred to as an A-scan but the geometry of the body under test is shown on the display. The geometry of the body under test is particularly apparent when the body under test is shown in cross section. This is possible if the wall thickness of the body under test is known. Since the insonification angle at which the sound is insonified into the body under test is known, it is also possible to image the path the sound travels through the body under test. The image yields particular information if the dimensions of relevant regions to be inspected can be included in the cross-sectional image. This is particularly helpful and easy when inspecting weld seams. Accordingly, one obtains an image in which two steel plates, which are joined together at their end through a weld seam, are shown in cross section. Accordingly, the weld seam is shown through lines between the two steel plates. With the help of the DGS or reference standard method and/or by calculating the extension of the flaw from the computed sound path differences, a detected flaw is directly shown true to scale in this cross-sectional image.

Accordingly, it is apparent which path the sound takes from the array probes through the body under test and in which legs or at which sites the sound hits the flaw. The prerequisite of such a system is, as already explained, that the insonification angles and the wall thickness of the body under test are known. From this information, the sound path for each leg and, as a result thereof, the transition from one leg to the next or the point at which the reflection of the sound from the coupling surface or from the back wall occurs is easy to compute.

On the basis of this image, it is possible to give the operator relevant information about the flaw, in particular with respect to its size and orientation, if the operator proceeds according to the method described herein after.

The discovered flaw is signaled through at least two flaw signals that result from the two substitute reflector sizes or from the differences in the sound paths, so that it is possible for the operator to recognize at first glance how the flaw extends in different directions. One thus obtains a two-dimensional image of the flaw.

The accuracy of the method of the invention can be increased if the flaw is not only inspected from two but from several directions and if a corresponding number of images are superimposed.

In a particularly advantageous implementation variant, the ultrasound apparatus or a processor or computer located therein calculates from the flaw sizes already obtained from different directions a top view of the flaw, so to say an image of the flaw in the plane of the body under test. Advantageously, this top view can also be shown on the display, simultaneous with the cross sectional image; meaning the display is divided into two views. Preferably, the relevant region, for example the weld seam, is shown through lines in the top view. The flaw length in the plane of the body under test can thereby be advantageously evaluated automatically according to the half-value method. For this purpose, an electronic and/or mechanical movement of the array probes alongside the weld seam is needed to determine the position of the probe.

In the top view, the flaw is preferably shown in an x-y diagram in which the width is plotted in millimeters or in another suited unit on one of the axes and the length of the flaw on the other axis. According to the invention, the scaling is automatically determined upon computing this image in the top view.

Advantageously, upon storing of individual relevant cross sectional images, the A-scans are also stored in the background.

The array probes can be passed both manually and mechanically over the bodies under test. In another advantageous implementation variant, they comprise a push-button for receiving the zero point position at the beginning of the testing operation. This means that testing begins at a defined location on the body under test, this location being stored in the system. It is thus possible to retrace later on relevant positions of the array probes on the basis of the stored data. For this purpose, the array probes comprise means that serve to indicate the respective position on the surface of the body under test with reference to a site that existed at the time the measurement started. This may for example occur with the help of a digital camera that is solidly connected to the housing of the array probes. It is oriented such that it covers the surface of the body under test. It should deliver an image of this surface in the closest possible proximity to the site at which a central beam of the active sound element passes through the surface. By means of this digital camera, an electronic image of the surface portion that is respectively located underneath the lens of the digital camera, meaning that lies in the object plane, is taken. The portion may for example have the dimensions of a few millimeters, for example of 2×2 or 4×4 mm. Preferably, an image of the respective surface portion is captured by the digital camera at given fixed intervals. In this connection, the reader is referred to the application DE 100 58 174 A1 to the same applicant.

In principle, it is possible to image the flaw in three dimensions. This is particularly possible if the array probes are moved along the flaw or if such a movement is simulated.

If the geometry of the weld seam is known and is stored in the ultrasonic apparatus or in the computer, both spatial limit values and limit values with respect to the amplitude to be taken into consideration can be entered. If the zero point position has been determined at the beginning of measurement, the distance of the array probes from the weld seam can be calculated any time on the basis of the leg length or of the wall thickness and of the insonification angle. Accordingly, it is possible, with the help of diaphragm tracking, to image on the monitor the region of the weld seam only, irrespective of the position of the array probes.

With the help of the described diaphragm tracking, it is also possible to select the flaws that are to be imaged in the form of a top view. It may for example make sense to image a flaw only if it has a certain size. With respect to the flaw size, a minimum and a maximum amplitude to be taken into consideration is entered as the diaphragm. It is also possible only to enter the maximum amplitude, it being further determined that a flaw is only shown if it exceeds half of the maximum amplitude.

Other features and advantages will become more apparent upon reviewing the claims and the following non restrictive description of embodiments of the invention, given by way of example only with reference to the drawing.

### BRIEF DESCRIPTION OF THE DRAWINGS

FIG. 1: is a simplified diagram of the sound path of ultrasonic signals through a body under test, starting from two array probes.

FIG. 2: the measurement data obtained, imaged by way of example in accordance with the invention in a top view.

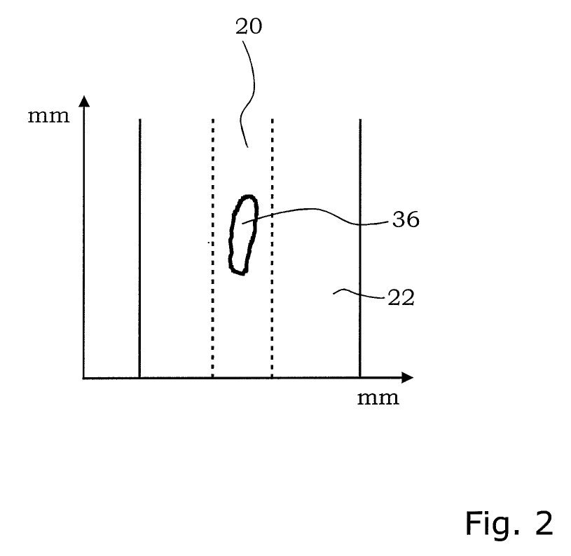

FIG. 3: an embodiment of the invention of an ultrasonic apparatus.

### DETAILED DESCRIPTION OF THE INVENTION

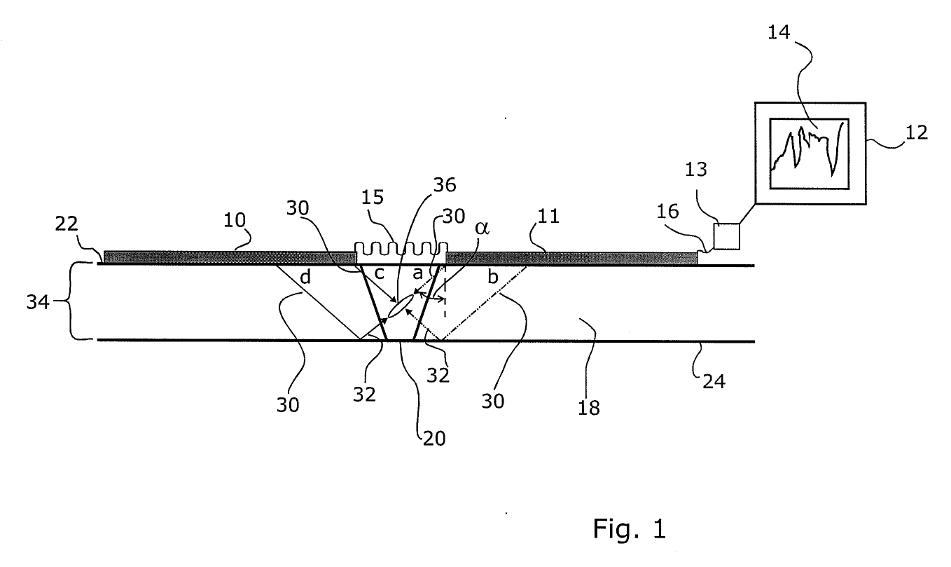

FIG. 1 shows the schematic structure of an ultrasonic measurement with a first array probe 10 and with a second array probe 11 in cross section. In principle, more array probes 10, 11 can be utilized. The array probes 10, 11, which contain several pulsers and receivers each, are connected through a line 16 to an electronic unit 13 and therethrough to a monitor 12, which in turn comprises a display 14. In the exemplary embodiment shown, there is an electronic connection 15 between the array probes 10, 11; but they may also be connected one by one to the electronic unit 13. Instead of the line 16, another type of connection, such as a radio connection, may also be envisaged. The array probes 10, 11 may also be configured such that pulser and emitter are disposed separate from each other. Within the frame of the description given herein after, it is presumed however that the pulsers and the emitters are located in the array probes 10, 11 and that measurement occurs with the help of the echo-pulse method.

The electronic unit 13 serves for controlling emission of initial pulses and for computing and evaluating the received ultrasonic signals as well as for providing data for imaging results on the monitor 12. For this purpose, it comprises an appropriate processor.

In the instant case, the body under test 18 is a portion of a steel plate that is connected to a second steel plate through a weld seam 20. The body under test 18 comprises a coupling surface 22 and a back wall 24, the array probes 10, 11 being disposed on the coupling surface 22. Between the coupling surface 22 and the back wall 24, insonification directions or sound paths a, b, c and d are outlined in the form of (continuous or dashed) lines. Starting from the array probes 10, 11, the sound is at first insonified obliquely into the body under test in the form of initial pulses at a predetermined angle •, forms a first leg 30, is then reflected from the back wall 24, forms a second leg 32, returns to the coupling surface 22 and to the other array probe 10 or 11. It is expressly noted that this is only a schematic, very simplified image that is not to be understood technically but is rather intended to better illustrate the fundamental context of the invention.

The oblique insonification can for example be achieved by using phased-array probes 10, 11.

It is easily possible to calculate the length of a leg 30, 32 or the point of transition from one leg 30, 32 to the next from a wall thickness 34 and from the angle •. If it is known which leg 30, 32 hits the flaw 36, the approximate distance the flaw 36 is spaced from the array probes 10 or 11 can be deduced therefrom. It is at least clear that the flaw is located on the path of the corresponding leg 30, 32.

If the sound hits a flaw 36 such as a crack, it is at least partially reflected and returns, depending on the orientation of the flaw 36, to the receiver as an echo signal.

Advantageously, the measurement data obtained are imaged on the display 14 in a cross-sectional view. The coupling surface 22 and the back wall 24 as well as the weld seam 20 are shown as lines in a diagram, in which length units can be plotted on an x-axis and on a y-axis respectively.

When testing the body under test 18, the array probes 10, 11 are at first placed onto the coupling surface 22 and ultrasonic pulses are insonified into the body under test 18 at certain angles • with the second array probe 11 (here the right one). If the sound hits a flaw 36, an optimal flaw signal 40 is grown. In this context, to grow means that the operator tries to find maximum flaw signals and to image them. In the present example, growing occurs on the basis of the leg a of the second array probe 11. In the instant case, growing occurs by electronically displacing the virtual probe.

Since the wall thickness 34 and the angle • are known, the other insonification positions can also be computed and the virtual probes can be actuated accordingly, one after the other (legs b, c and d).

Accordingly, one obtains four insonification positions from which eight measurement values, namely four travel time values and four amplitude values, can be derived. The shape of the flaw 36, namely whether it is voluminous or planar, can be directly deduced by comparing the amplitude values. Also, evaluation of the four travel time values can be used to determine the size since the extension results from the difference between the travel time for a complete through transmission in a V-shape and the sum of the travel times (here legs b and d).

From the measurement values, the substitute reflector size is preferably determined according to the DGS or reference standard method and/or from the sound path differences and is imaged on the display 14, meaning in a cross-sectional image, as the first flaw signal. One obtains a measurement image which the operator stores at need in a data memory that can be provided in the electronic unit 13.

It may also make sense to image the flaw signals as a function of the amplitude obtained in a coded, more specifically in a color-coded manner. Flaws 36 exceeding a certain size can for example be imaged in a signal color such as red.

The flaw signals shown are displayed true to scale on the display 14. In the exemplary image, it appears that the flaw extends more transverse to the sound path 28 than to the sound path 26. If other insonification angles are used for evaluation, one obtains an even more accurate image of the flaw 36. In principle, the insonification positions are changed along the orientation of the two array probes 10, 11, meaning so to say transverse to the flaw 36, or toward it or away therefrom. Additionally, the insonification positions can for example be varied lengthwise with respect to the flaw 36, either through manual or through virtual displacement of the pulsers/receivers of the array probes 10, 11.

The image of the invention gives the user of the ultrasonic test apparatus or the operator a very accurate idea of the orientation, the size and the volume of the flaw 36, and is in particular indicative of whether the flaw is a voluminous or a planar flaw such as a crack.

In a particularly advantageous implementation variant, the data underlying the measurement images or the evaluation image are further shown in a top view. This means that the body under test 18 and the weld seam 20 are also shown through lines on the monitor 12 or on the display 14 for example. The data obtained, which underlie the flaw signals, are converted in such a manner that the extension of the flaw 36 in the longitudinal plane of the body under test 18, meaning in the plane extending transverse to the cross-sectional image 38, is displayed on the display 14. This image also occurs in a diagram comprising length units both on the x- and on the y-axis so that the length and the width of the flaw 36 are readily apparent in the longitudinal plane of the body under test 18.

Parallel to the imaging of the measurement data in accordance with the invention, A-scans can also be generated. These scans can be either stored in the background or be displayed simultaneously on the display 14.

Anyway, different images, meaning cross-sectional images 38, the evaluation images 44 and the top views 46 can be shown simultaneously on the display 14, but it may also make sense for the operator to be capable of switching between these images.

Another advantage of the imaging of the invention is that only the region of the body under test 18 to be inspected is shown on the monitor 12 or on the display 14 that is of interest for inspection. This may for example be the weld seam 20 to be inspected. For this purpose, both spatial limit values and limit values regarding the amplitudes to be considered are entered into the ultrasonic test apparatus and taken into consideration prior to measurement. This means that only those signals are being displayed, the origin of which is either the region and/or the environment of the weld seam 20 to be inspected and/or the signal strength of which exceeds the minimum limit value.

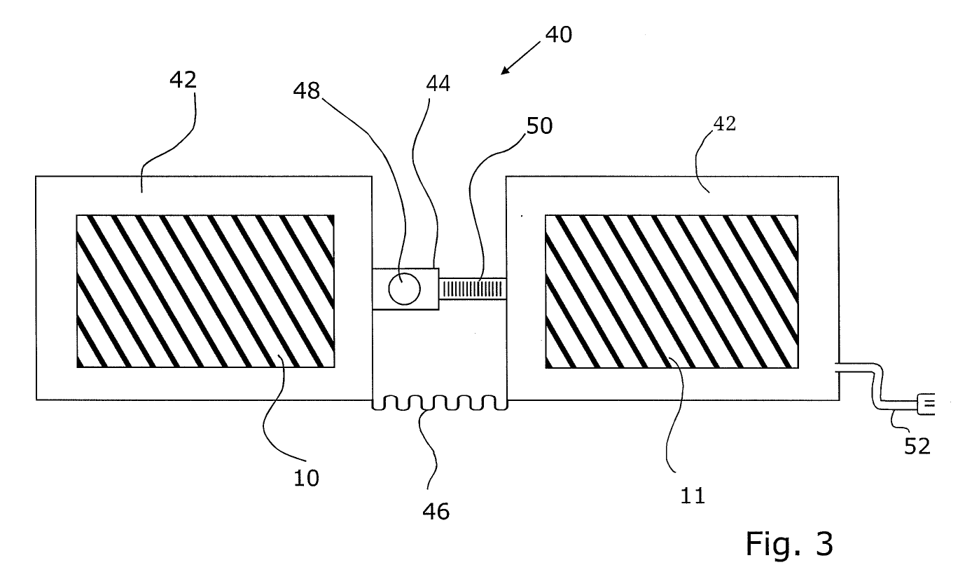

FIG. 3 shows by way of example an implementation variant of an ultrasonic test apparatus of the invention or a preferred arrangement of the array probes 10, 11. A frame construction 40 comprises reception regions 42 for receiving the two array probes 10, 11. The two reception regions 42 are also configured in a frame-like fashion and are joined together through a mechanical connection 44. There is further shown a cable 46 that also joins the two reception regions 42 together. The array probes 10, 11 can be inserted into the reception regions 42. They are securely held in the reception regions 42. Preferably, the mechanical connection 44 comprises an adjustment device 48 through which the distance between the reception regions 42 is adjustable. Moreover, there may be provided a scaling 50 from which the distance between the reception regions 42 can be read. Within the reception regions 42, there is provided a connection (not shown) for the array probes 10, 11 through which these probes are supplied with energy and which also allows for data exchange. The frame construction 40 preferably comprises in only one reception region 42 a connection 52 for the electronic unit 13 or another electronic apparatus such as a computer (PC) or the monitor 12 which has not been illustrated herein.

In a particularly advantageous implementation variant, the frame construction 40 or the array probes 10, 11 are not guided manually, meaning by hand, over the body under test 18; tracking occurs automatically instead. For this precise case of application, the design of the ultrasonic test apparatus of the invention or the method of the invention are very helpful since a lot of data can be collected within a very short period of time and the flaw can be grown later on, on the basis of the already obtained data or flaw signals.

From the above it appears that the apparatus of the invention and in particular the method for inspecting workpieces carried out with this apparatus are suited for serial measurement. An example for serial measurement is the inspection of weld connections on pipelines. The test apparatus is at first docked to a workpiece or to a few workpieces, then the serial inspection is performed.

The invention has been explained by way of example only, the structure of an ultrasonic test apparatus can differ greatly. Also, array probes 10, 11 of different construction types can be used. Depending on the body under test 18, it may be sensible to repeat testing from another direction. In the case of planar test bodies 18, the surface located opposite the coupling surface 22 can for example be used as the coupling surface 22.

What is claimed is:

1. A method of imaging ultrasonic signals obtained with the help of an ultrasound test apparatus for non-destructive testing of a body, said ultrasonic test apparatus comprising at least one first array probe and one second array probe, several pulsers generating initial pulses each and several receivers receiving ultrasonic signals each, comprising the steps of:
placing the array probes onto a coupling surface of the body under test;
insonifying ultrasonic pulses at certain angles (•)into the probe under test with the first array probe;
receiving ultrasonic signals with the help of the first array probe;
finding and growing a flaw from a first insonification direction (a);
computing several insonification positions and directions (b, c, d) of the two array probes on the basis of known wall thickness of the body under test and of known angle (•) of the first direction (a); and
determining the extension of the flaw on the basis of travel times and amplitudes of the insonification directions (a, b, c, d).

2. The method as set forth in claim 1, wherein the flaw is insonified from at least four insonification positions and that four travel time values and four amplitude values are evaluated.

3. The method as set forth in claim 1, wherein the ultrasound energy is injected into the flaw from additional insonification positions.

4. The method as set forth in claim 1, wherein the insonification positions vary across the flaw.

5. The method as set forth in claim 1, wherein the insonification positions alongside the flaw vary.

6. The method as set forth in claim 1, wherein the flaw is imaged true-to-scale in an evaluation image on the display of a monitor.

7. The method as set forth in claim 1, wherein the evaluation image contains a cross-sectional image and that at least one coupling surface and a back wall of the body under test are to be seen.

8. The method as set forth in claim 1, wherein, when a weld seam is inspected, this weld seam is also shown.

9. The method as set forth in claim 1, wherein the respective position of the angle-beam probe is permanently acquired on the surface of the body under test.

10. An ultrasonic test apparatus for non-destructive testing of a body comprising:
at least one first array probe and one second array probe respectively comprising several individual pulsers generating initial pulses and several receivers receiving ultrasonic signals; and
an electronic unit that is connected to the array probes and comprises a processor for controlling emission of the initial pulses and for computing and evaluating the received ultrasonic signals as well as for providing data for imaging results.

11. The ultrasonic test apparatus for non-destructive inspection of a body as set forth in claim 10, wherein the two array probes are mechanically joined together.

12. The ultrasonic test apparatus for non-destructive inspection of a body as set forth in claim 11, wherein the two array probes are mechanically connected together in such a manner that the distance between the array probes is variable.

13. The ultrasonic test apparatus for non-destructive inspection of a body as set forth in claim 11, wherein the two array probes are disposed in a frame construction.

14. The ultrasonic test apparatus for non-destructive inspection of a body as set forth in claim 11, wherein the distance between the array probes is permanently acquired electronically and that this acquired distance is transmitted to the electronic unit for further computing.

15. The ultrasonic test apparatus for non-destructive inspection of a body as set forth in claim 10, wherein the probe is solidly connected to a means that serves for acquiring the respective position of the angle-beam probe on the surface of the body under test.
